(19) United States
(12) Patent Application Publication
(10) Pub. No.: US 2008/0246652 A1
(43) Pub. Date: Oct. 9, 2008

(54) GPS PATHFINDER METHOD AND DEVICE

(76) Inventor: Scott Lewis, West Palm Beach, FL (US)

Correspondence Address: MCHALE & SLAVIN, P.A., 2855 PGA BLVD, PALM BEACH GARDENS, FL, 33410, US

(21) Appl. No.: 11/696,532

(22) Filed: Apr. 4, 2007

(51) Int. Cl. H04B 7/185; G01S 1/04

(52) U.S. Cl. 342/357.1; 342/357.13

(57) ABSTRACT

A device and system for use in the early stages of search and recovery after a disaster. The device incorporates a GPS and a radio with very simplified, pre-programmed instructions which are uploaded automatically in the device's memory via wireless technology prior to the unit's first use at a disaster site. Maps of areas to be searched are uploaded into the device and the areas covered during the search are retained in the devices' memory. A unique feature enables the searcher to quickly indicate a specific need or service at a particular location during the search. Via wireless technology Areas that have been searched during a day are downloaded to a base unit and areas to be searched the following day are uploaded to the portable units at the beginning of the day. Radios on the units enable the searchers to audibly communicate with each other. The system can be employed by cleanup teams, insurance adjusters also and any number of post incident response teams both focused on short and long term recovery operations.

### FIELD OF THE INVENTION

The present invention relates to a system for a variety of search and recovery operations after a disaster. The system is designed to be used by a wide variety of recovery and rescue workers to methodically search for victims in areas affected by disasters, assess property damage, and identify and deliver special areas of need.

### BACKGROUND OF THE INVENTION

The present invention relates to a disaster recovery system for use by individuals which incorporates a methodical approach to a variety of disaster search and recovery operations. The system is designed so that individuals unfamiliar with the affected disaster areas can easily navigate these areas and readily record locations wherein specific assistance is required. More particularly, the present invention relates to a combined Global Positioning System (GPS) receiver and radio transceiver which is operable for sending GPS data and other information to other GPS/radio units.

Until recently, with the ready access and low cost of GPS devices, it was very difficult and sometimes impossible to perform adequate search and recovery operations in areas that have been totally devastated by natural disasters such as hurricanes or earthquakes. Extremely large hurricanes such as Katrina in New Orleans and Andrew in South Florida have resulted in total destruction and devastation in the areas they have hit. After Hurricane Andrew there were no homes, buildings, street signs or other landmarks left standing so that an individual could pinpoint their location or indicate to other individuals where assistance was required. The flooding caused by Hurricane Katrina in New Orleans left the city and surrounding areas in the same condition, with no points of reference. Conventional maps become useless in these situations because they rely on points of reference at specific locations on the ground.

The recent developments in GPS have resulted in GPS devices that are small enough to be hand held. Improved location software and access to Wide Area Augmentation System (WAAS) have enabled the determination of the position of an object to within one meter or three feet of its actual location. These GPS devices do not require any landmarks or reference points to determine the location of an object. Thus, once the object's longitude and latitude have been recorded in the device it is relative easy to return to the same location using these coordinates. The longitude and latitude of an object is known as its waypoint. Software has been developed which enables the generation of electronic maps from waypoints of known locations. These maps are the ones which are commonly used in the navigation systems found on many of today's automobiles. The location of the cursor representing the GPS unit on the navigation map is the result of real time, way point determination.

In addition to the growing popularity and demand for GPS navigational devices, portable two-way radios are once again enjoying widespread popularity. In 1996 the Federal Communications Commission (FCC) established the Family Radio Service (FRS) in order for families and other small groups to be able to communicate with one another over very small distances (usually less than two miles) at no charge and without the need for an FCC license. Another service is the General Mobile Radio Service (GMRS). This is a personal radio service available for the conduct of an individual's personal and family communications. It operates in the UHF frequency band. When combined with a repeater it can also be used for radio communications. Currently, there are a number of commercially available two-way radios which are designed for use with the FRS and the GMRS.

Recently the handheld GPS units have been combined with portable two-way radios which operate on the FRS and GMRS frequencies. These combination units enable small groups of individuals to be in the wilderness, amusement parks, sporting events, etc. while remaining in voice communication with each other.

Some of the problems associated with the currently available GPS/radio units include the operation of numerous controls and overly complex software designs, in addition to the radio controls, which must be operated to transmit location data between the units. In addition, most of the current units will only transmit their location data when the user of the units elects to do so. This can become a problem. For example, parents may want to monitor the location of their children in an amusement park, but can only do so if the children periodically transmit their location information back to their parents.

Another problem with these units is the lack of privacy. These units broadcast on the FRS which is an unlicensed, shared communication service and communications from different persons are normally transmitted simultaneously causing interference. This is true in areas where these units are popular such as amusement parks, sporting events and concerts. Many FRS and GMRS radios incorporate continuous tone coded squelch systems (CTCSS) to suppress the unwanted conversations. However, CTCSS does not prevent someone without CTCSS or someone who has turned their CTCSS off to overhear unwanted conversations. These unauthorized individuals can utilize the information they overhear to determine someone else's location.

### DESCRIPTION OF THE PRIOR ART

A prior art device which combines a handheld GPS receiver and a radio is disclosed in U.S. Pat. No. 7,142,900, issued to Straub. The unit includes a GPS receiver and a radio transceiver. The GPS receiver operates in conjunction with cartographic data which is downloadable from cartridges. This enables the user to download a map of the immediate vicinity and determine their current location with respect thereto. The radio is a two-way radio which operates on the Family Radio Services (FRS) portion of the Citizens Band Radio Services. The broadcast range of these radios is generally two miles or less and they are commonly used by family and friends to keep in touch with each other in areas such as amusement parks and other recreational areas. The unit also has GMRS capability. This unit also has a “polling” function. This function is performed when a pushbutton or other device is activated to transmit a radio request to the other GPS/radio units to indicate their locations. The other units will automatically transmit their locations to the unit that had made the request. These locations can then be displayed on the requesting unit's display and the user can readily determine the locations of the other members of their party. While this unit can download a given day's track to a base unit, it does not have blue tooth technology and therefore must be hard wired to the base unit to store its track. Further, the use of the unit is far too complicated for the common user without prior instructions. In addition the user cannot associate a written description or code with a specific way point in the unit.

U.S. Pat. No. 6,268,798, issued to Dymek et al. discloses a locator system for firefighters which incorporates a GPS receiver and a memory. The firefighter activates the locator unit as he enters a building and the unit records his path through the building. Should he become disoriented or injured he can activate the memory in the unit and the unit will provide a reverse indication of the path that was traversed up to that point. By following these reverse directions the firefighter is able to safely exit the building. The unit can also communicate with a home base and transmit the path traversed by the firefighter to the home base so it can be uploaded to another unit. This second unit is employed by a rescuer into the building and by retracing the path the lost or injured firefighter is located. While these units can download a path traversed by a user, they are not equipped to be uploaded with a path to follow or an area to search. Further, they cannot associate a specific written condition or code with a way point.

U.S. Published Patent Application No. 2003/0080897, filed by Tranchina et al. discloses a combination GPS receiver and radio. The GPS receiver operates in conjunction with a memory to enable a user to retrace the path they had just traversed. This feature enables a user to return to their starting point without getting lost. The radio operates on the General Mobile Radio Service (GMRS) or Family Radio Service (FRS) portion of the Citizens Band Radio channels. The broadcast range of these radios is generally two miles or less. While these units can download a path traversed by a user, they are not equipped to be uploaded with a specific path to follow or an area to search. In addition they cannot associate a written description or code with a specific way point.

Therefore what is needed in the art is a GPS/radio portable unit which can be uploaded with a map of an area to be searched, after a disaster has occurred, and a method of recording the portions of the search area that the user will traverse on any given mission and track what has been searched over a given mission. Also, the portable unit should be capable of wirelessly downloading to a base unit the portions of the search areas that have not been searched during the day. Given the number of the units being used after an incident, hard wiring for uploads and downloads is not practical and is far too time consuming. The unit should also enable the user to input specific information and/or recovery needs without complicated commands, all of which needs to be downloaded rapidly to a base unit for efficiency of the operations.

### SUMMARY OF THE INVENTION

The present invention is a device and system for use in the various stages of search and recovery after a disaster. The device incorporates a GPS and a radio with both FRS and GMRS capability. Maps of areas to be searched are uploaded into the device and the areas covered during the search are retained in the device's memory. A unique feature enables the searcher to quickly indicate a specific need or service at a particular location during the search. Areas that have been searched during a day are downloaded to a base unit and areas to be searched the following day are uploaded to the portable units at the beginning of the next day—all via wireless technology. Radios on the units also enable the searchers to audibly communicate with each other.

Accordingly, it is an objective of the instant invention to provide a portable device equipped with a GPS receiver which enables a searcher or other individual to navigate and search a specific area after landmarks and other reference points have been eliminated or destroyed.

It is a further objective of the instant invention to provide a portable GPS device that records the areas searched or covered by a searcher or individual during a day or other period of time. The tracks can be overlaid on to other units' tracks in the base station.

It is yet another objective of the instant invention to provide a portable GPS device that downloads areas not covered during a search to a base unit and receives uploads of different areas to be searched the next day or time period via wireless technology.

It is a still further objective of the invention to provide a portable GPS device equipped with a radio for audible communication with other searchers or individuals.

It is yet a further objective of the instant invention to provide a portable GPS device equipped with a radio which can indicate the locations of other similar devices without input from the operators of the other devices. Real time tracking is thus achieved as well.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a perspective view of a combined GPS/radio device according to a preferred embodiment of the present invention;

FIG. 2A is a block diagram of the components of the GPS/radio of FIG. 1;

FIG. 2B is a block diagram of a communications network linking the GPS/radio unit of FIG. 1 with a plurality of other GPS/radio units;

FIG. 3 is a flow diagram of the procedure utilized by the search teams;

FIG. 4 is a flow diagram of the procedure utilized by a cleanup contractor; and

FIG. 5 is a flow diagram of the procedure utilized by insurance company adjusters.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

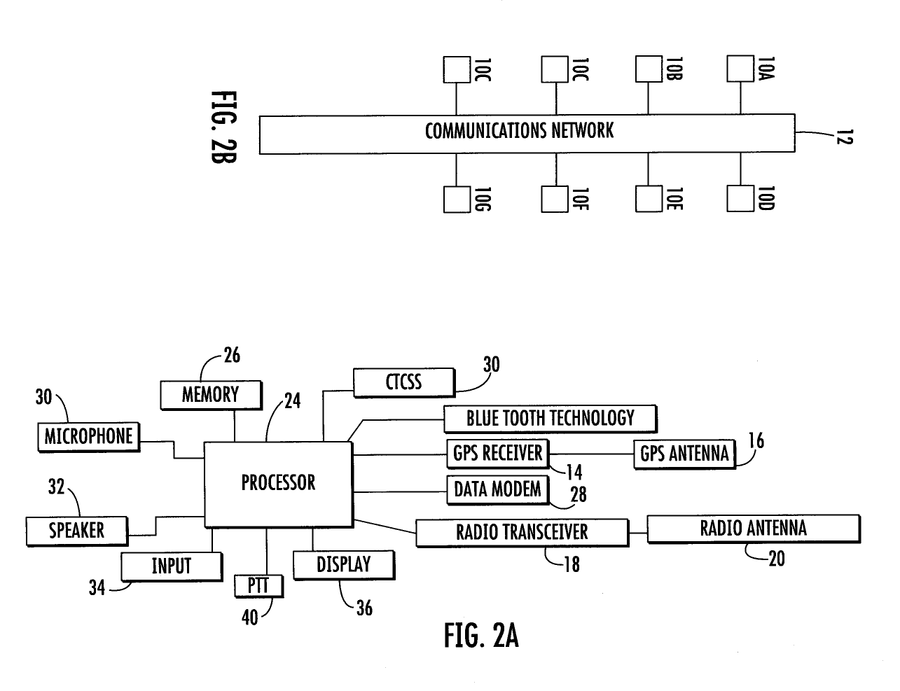

A portable GPS receiver is combined with a radio transceiver into one unit 10 in a preferred embodiment of the present invention as illustrated in FIG. 2A. A plurality of other similar GPS/radio units 10A-10G communicate with each other utilizing a communications network 12, as illustrated in FIG. 2B. The GPS/radio units 10A-10G determine their various locations utilizing GPS and can then transmit these locations to the other units over a wireless network. In this manner the locations of all the units can be determined and monitored by any one of the units. The preferred embodiment of the present invention is also provided with a radio. The units can also communicate with each other over a public radio network such as FRS or GMRS.

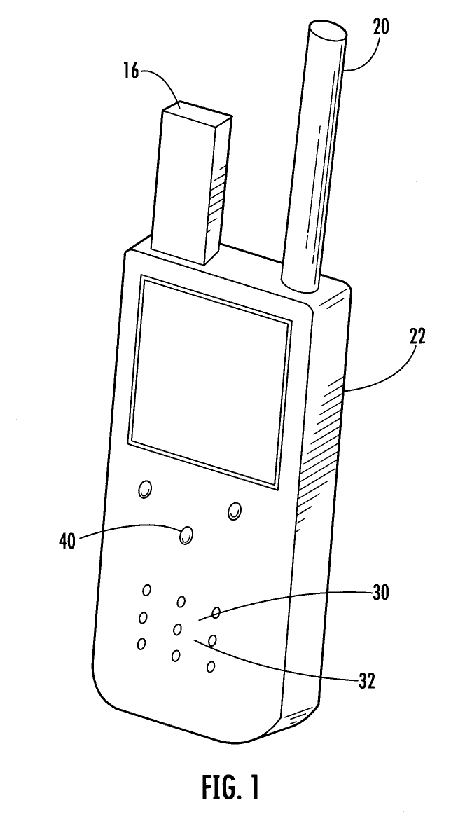

Referring to FIGS. 1 and 2A the GPS/radio of the present invention will now be described. The GPS/radio unit 10 includes a GPS receiver 14, a GPS antenna 16, a radio transceiver 18 and a radio antenna 20 all mounted in or on the GPS/radio housing 22. The GPS receiver is electronically coupled to processor 24 which in turn is electronically coupled to a memory 26. The memory 26 can be built into the unit 10 or removably connected thereto, such as a flash memory stick or removable cartridge (both not shown). The memory will normally contain the information necessary to operate the unit 10. The memory can also be used to store cartographic data (electronic maps), waypoints or locations which the unit's operator wants to save, waypoints of the other units and other data which may be input into the unit 10. The radio transceiver 18 is electronically coupled to the processor 24 and a data modem 28. The data modem is utilized for transmitting and receiving data such as location data of the units.

The electronic maps stored on the removable memory devices can be readily displayed on the unit's display 36. Waypoints or areas traversed by the unit and stored in the memory can also be displayed on the display 36. In a preferred embodiment, the display 36 is a liquid crystal display (LCD) and is used to display other information in addition to navigational information. Any other type of display may also be used. The unit 10 also includes a microphone 30, a speaker 32 and an input 34. The microphone 30 and speaker 32 are conventional and can be the same type of microphone and speaker used on a conventional FRS or GMRS radio.

Input 34, in a preferred embodiment, is an alphanumeric keypad such as the keypad used on telephones. This permits the entry of letters, numbers and any other symbols found on keypads. Utilizing special software, almost any number, letter or symbol can be entered into the unit. This type of software is commonly available on cellular telephones. The input 34 could also be a microphone, a voice recognition input, a touch screen, a full keyboard similar to a Blackberry® or a menu driven display screen.

The GPS/radio unit also includes a continuous tone coded squelch system (CTCSS) 38 and a push-to-talk button 40. The CTCSS controls the audio output of the speaker so that only a desired transmission can be heard by the user of the unit 10. The push-to-talk button 40 can be any conventional pushbutton switch or control device normally found on short range two-way radios. The push-to-talk button 40 is coupled with the processor 24 to combine two important functions in a single button. The push-to-talk button 40 is operable to both initiate transmission of voice communications and transmission of a radio signal which indicates the GPS location of the unit. Additionally this feature permits updated location information to be automatically transmitted each time the user transmits a voice transmission.

Activation of the push-to-talk button can also trigger a transmission of a radio signal including GPS derived location data indicating the location of the unit transmitting the radio signal. This transmission occurs normally shortly after the voice communications are complete and the push-to-talk button has been released. The processor 24 keeps the radio transceiver enabled for approximately 100-300 milliseconds to allow the transmission of the location data. The GPS/radio unit 10 can also include another feature which enables other individuals determine its location. This is a “polling” feature wherein one unit 10 sends a request to the other units 10A-10G for them to transmit their locations back to the requesting unit. This request can be performed manually by the operator of the requesting unit 10 or the requesting unit can be programmed to perform this operation automatically at pre-selected time intervals. The locations of the other units 10A-10G are updated on the electronic map of the requesting unit so that at any time all the units can know where all the other units are. Any and all of the units can perform this location request. If the units are programmed to perform this automatically, then no input is required by any of the operators.

Another optional feature of the GPS/radio unit is a coding or encryption system. This system can employ any of the known coding or encryption schemes such as public or private key encryption methods. To employ this feature a group of GPS/radio users would enter an agreed upon code into their units prior to use. The code would then encrypt the transmitted location data and the receiving units would be able to decrypt this information. This prevents other, unauthorized units from tracking the location of other units. This can be useful with groups such as law enforcement individuals.

GPS/radio units which include all of these features are complicated to operate and numerous intricate operational procedures must be memorized and/or deciphered to obtain the desired results. Many individuals who are involved in search operations after disasters such as hurricanes are ordinary individuals who are not familiar with the operation of these GPS/radio units. Therefore, for the search missions to be successful, these units need to be modified so that anyone could readily operate them.

The first modification is a modification of the hardware. This modification involves equipping the units with a Bluetooth® communication system. This communication system enables the rapid transfer of large amounts of data wirelessly between devices within a close proximity (10-20 feet). This wireless communication system enables software modifications of the GPS/radio unit, which in turn enable uncomplicated operation of the unit, and transmission of data between the portable GPS/radio unit and a base station.

Using as an example a Garmin Rhino 500 series GPS/radio the following modifications to the software in the unit are made prior to its use in the search operations. Once these modifications have been made they do not need to be changed until the units are returned to normal service. These modifications can be made utilizing Bluetooth® communications from a base station.

First the GPS/radio unit are uploaded with the following information:

User name

User symbol

GMRS channels to be used—one national emergency frequency

FRS channels to be used

CTCSS code for each team

CTCSS code for the task force

A list of radio frequencies to scan which only include those listed above

Next the radio is set up with the following parameters:

Sending location

Permit polling function

GMRS power level

Scramble codes

Repeater channels

Headset type—Bluetooth® enabled

VOX level

Microphone sensitivity

Next the following tones are selected and activated:

Call tone

Roger tone

Ring tone

Vibrate

Message beep

Key beep

Power beep

Turn warning

Next the new contact page overview data is provided:

Only the team members plus the base station

Identify the Team Leader's unit

Next the main page functions are set:

A position icon for the base unit is selected

A position icon for the team leader is selected

A position icon for the team members is selected

A single county map is entered into the unit

The pan map feature is turned off

The navigate function is turned on

The recalculate feature is turned off

The data fields are turned off

The guidance text is turned off

The set up map is pre-set

The measure distance feature is turned off

The declutter feature is turned on

Next the data fields are completed:

The options are pre-programmed

The guidance text is turned off

The map is set up

In the general set up, North is selected as up

In the track set up, the scale is selected

In the map points, the scale is selected

The Text is set up

The map information is entered

The measure distance feature is deleted

The compass is deleted

Next the main page is changed

The satellite page is deleted

The trip computer page is deleted

The mark waypoints feature is turned on. Each waypoint name has an Emergency Support function (ESF) associated with it. There is also a 1-2 word descriptor for each waypoint.

The find menu is restricted to waypoints, the base and team contacts

The track page is only for the team

The routes page is only for the team

The highway page is deleted

The proximity page is deleted

The calendar is delete

The alarm clock is deleted

The calculator is deleted

The stop watch is deleted

The sun and moon feature is deleted

The hunt and fish feature is deleted

The games are deleted

Next the Tracks page is:

Pre-programmed daily

The back track is pre-programmed

The track log is pre-programmed

Next on the Routes page:

Certain waypoints are pre-programmed

The page is cleared daily after being downloaded

The routing methods are pre-programmed

Navigating a route is set only to a day by day target area

The highway page is deleted

Next the Setup page is pre-programmed to the above settings.

Next the display setup page is pre-programmed as follows:

The display mode is selected

The color scheme is selected

The backlighting time is chosen

The backlight intensity is chosen

Next the units set up page is deleted

Next the LORAN TD format is deleted

Next the Heading setup page is pre-programmed

Next the Welcome setup page is pre-programmed

Next the interface setup page is pre-programmed

Finally the proximity waypoints are deleted.

After these modifications have been performed the team members go out into the designated search areas with their portable hand held GPS/radio units. At the beginning of every day a different route or search area is programmed into each unit. Preferably each team will have the same route or search area and different teams will have different routes or search areas. As the team members cover the routes or search areas they will encounter individuals or locations which require specific needs. These needs have been designated as Emergency Support Functions (ESF) and categorized with possible uses as follows:

ESF #1: Transportation: Monitoring assets and equipment, transportation safety, movement restrictions and damage impact and assessment.

ESF #2: Communications: Supplement existing systems without overwhelming capacity given a large scale operation.

ESF #3: Public Works and Engineering: Locating infrastructure protection and emergency repair, including roads, bridges, potable water, sanitation, utility grid emergency needs.

ESF #4: Firefighting: First responder's monitoring and coordination for incoming, out of region, fire rescue services following any disaster.

ESF #5: Emergency Management: Coordination and command resources, monitor and assign assets, and incident action planning.

ESF #6: Mass Care, Housing and Human Services: Follow up specialty resources as identified by first response teams with software waypoint system.

ESF #7: Resource Support: Logistics location, monitoring, dispatch and distribution, with emphasis on personnel from out of the area response teams within a given disaster zone.

ESF #8: Public Health and Medical Services: Logistics location including pharmaceutical supplies and medical personnel management; D-Mort service teams' and EMS personnel locations and assignments and precise locations.

ESF #9: Urban Search and Rescue: Accurate resource management and detailed tracking and mapping for 100% coverage of the affected area without costly re-searching areas previously covered.

ESF #10: Hazardous Materials: Locate and identify the precise location of various threats. Monitor and mitigate the needs to suppress these threats and prioritize the threats.

ESF #11: Food, Water and Natural Resources: Locate sources for mass food and water resources by sector. Food safety and security; locate historic properties protection and nutrition assistance.

ESF #12: Energy: Coordinate, dispatch, monitor and locate emergency energy needs and response units.

ESF #13: Military Affairs: Public safety and security—incoming units can be universally tracked and monitored for efficient management, including using military personnel for various other ESF function needs as required, including traffic management operations.

ESF #14: Public Information: Locates informational needs by street address and available resource allocation distributions.

ESF #15: Volunteers: Volunteer management of incoming personnel and resources to be distributed across ESF functions as needed using locator source system.

ESF #16: Law Enforcement: Coordinate the mobilization of law enforcement and security resources.

ESF #17: Animal Protection: Provide rescue, protective care and feeding for animals using GPS locator assistance.

ESF #18: Business and Industry and Economic Stabilization: Coordinate the response of State agencies in assisting local economic redevelopment via locator source system.

In addition to associating an ESF number with a waypoint wherein a particular need or service has been identified by the searcher, a 1-2 word descriptor can also be associated with the waypoint. This would help to clarify any ambiguities that a third party may have regarding a particular way point and emergency service that was associated with the waypoint. These descriptors could also be used to identify a particular need or resource that would be required at a particular area or site.

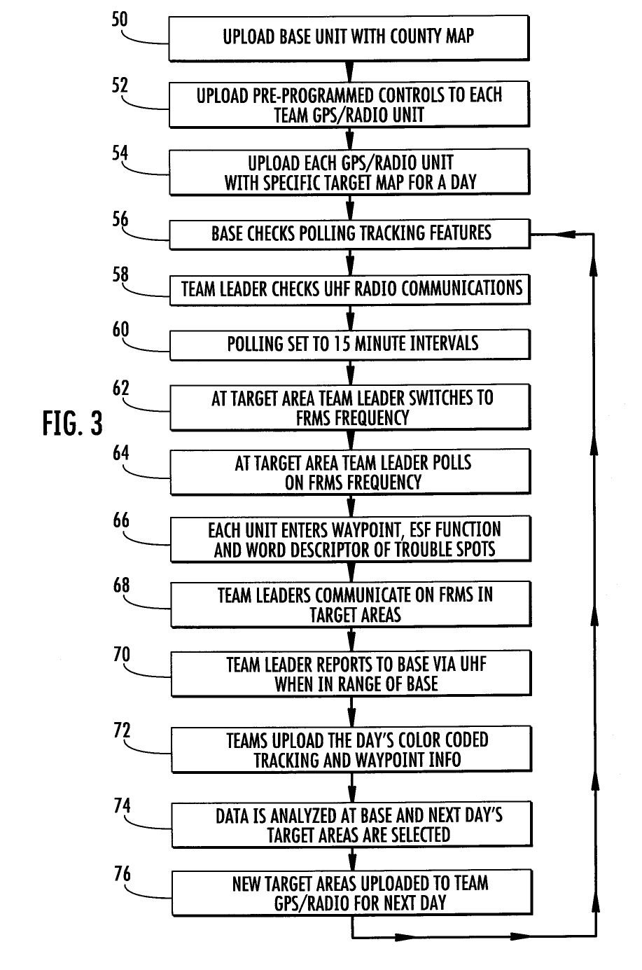

With reference to FIG. 3 the operation of a typical search would proceed as follows. The base unit is uploaded with a map of the county or area surrounding the site of the disaster at 50. The individual team GPS/radio units are uploaded with pre-programmed controls and settings at 52. The individual team units are uploaded with a specific target search map for one day at 54. The base unit checks the polling tracking features of the units at 56. The team leader checks the radio communications between his unit, the team members units and the base station at 58. These radio communications can be in UHF, VHF or 800 MHz frequencies. The polling feature of the field units is set for 15 minute intervals at 60. After the teams reach the target or search area, they switch their radios to operate on the FRS radio frequency at 62. The team leader polls the team members on the FRS frequency during the searching operations at 64. Whenever they reach a trouble spot the team members enter a waypoint, ESF number and descriptor into their individual GPS/radio units at 66. The team leaders communicate with each other over the FRS frequency while in the search area at 68. The team leader reports in to the base station over the UHF, VHF or 800 MHz frequencies when they are within range of the base station at 70. The team members upload the routes covered, searched areas and waypoints from that day to the base station at 72. While the upload is preferably preformed wirelessly, any other type of data transfer is acceptable. These routes or search areas may be color coded. The data uploaded into the base station unit is analyzed and the next day's search areas or route are determined at 74. The new search areas or route are uploaded into the teams' individual GPS/radio units at 76 and the procedure then returns to step 56. While the new routes are preferably uploaded wirelessly, any other type of data transfer is acceptable.

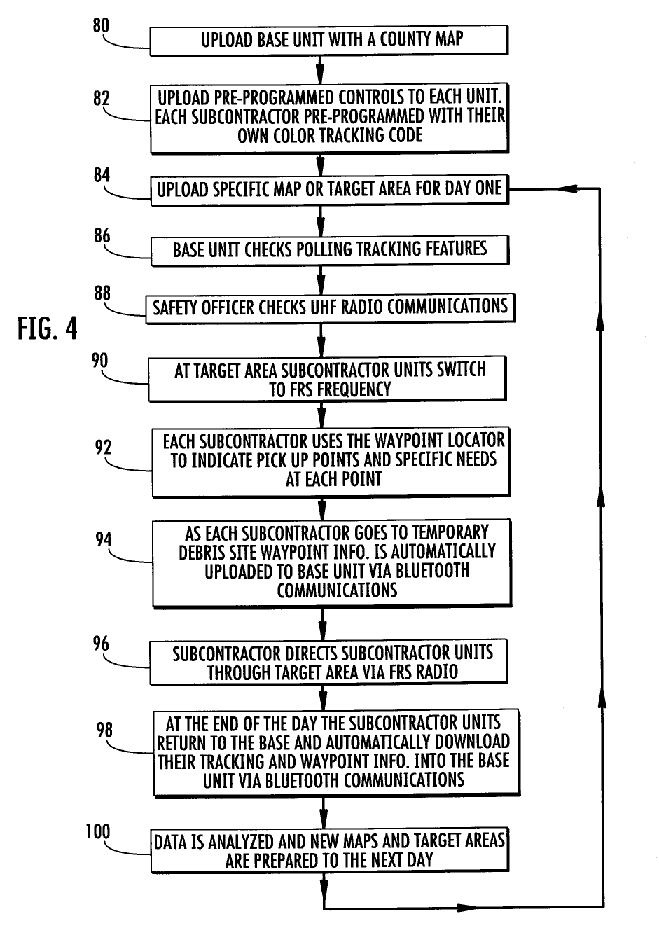

With reference to FIG. 4 the procedure of a typical cleanup operation after a disaster is described. The base unit is uploaded with a map of the county or area surrounding the site of the disaster at 80. The subcontractors' units are pre-programmed with controls, settings and color codes at 82. The subcontractors' units are uploaded with a specific map or target area for the day at 84. The base unit checks the polling tracking feature of the individual units at 86 prior to dispatching the subcontractors. The safety officer checks the UHF, VHF or 800 MHz frequency communications feature of the individual units at 88. Once within the target area the subcontractors' units are switched to operate on the FRS radio frequency at 90. Each subcontractor uses the waypoint locator to indicate a pickup site and the specific needs at each site at 92. The subcontractors proceed to a temporary debris site within the target area. At this location the waypoint information which they have collected that day is downloaded to a unit at the temporary debris site via Bluetooth® communications at 94. This information is subsequently sent to a base station. The subcontractor continues to direct the subcontractor units through the target area via FRS radio at 96. At the end of the day the subcontractor units return to the base station and automatically download their tracking and waypoint information to a base station unit via Bluetooth® communications at 98. The data is analyzed and new maps and target areas are prepared for the next day's operation at 100 and the procedure then returns to step 84.

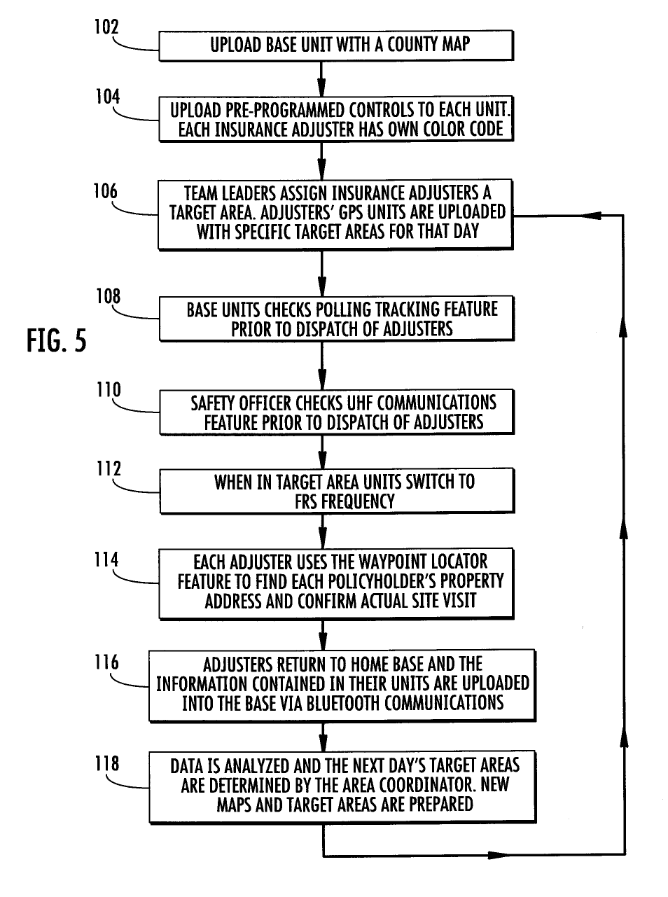

With reference to FIG. 5 the operation of a typical insurance company's adjuster's visit to a disaster area is described. The base station unit is uploaded with a map of the county or area surrounding the site of the disaster at 102. The individual insurance adjusters' GPS/radio units are uploaded with pre-programmed controls, settings and color codes at 104. The team leaders assign the insurance adjusters a target area and the adjusters' GPS/radio units are uploaded with the specific target areas to be covered that day at 106. The base station unit checks the polling tracking feature of the adjusters' units at 108, prior to dispatching the adjusters. The safety officer checks the UHF, VHF or 800 MHz frequency radio communications between the GPS/radio units at 110. After the insurance adjusters have entered the target area they switch their radios to operate on the FRS radio frequencies at 112. Each insurance adjuster uses the waypoint locater feature of their GPS/radio unit to locate each policyholder's property address and confirm the actual visit to the site at 114. The adjuster can then make notes regarding damages to the property in their own computers or other devices. The insurance adjusters return to the base station and the information contained in their units is uploaded into the base station unit via Bluetooth® communications at 116. The data is analyzed and the following day's target areas are determined by the insurance coordinator. New maps and target areas are prepared for the following day at 118 and the procedure then returns to step 106.

In addition to the users listed above, this system can be employed by any and all members of a first responder services such as Homeland Security, the military, the National Guard, the National Emergency Management Association (NEMA), Hazardous Material teams, non-governmental responders, volunteer groups, long term recovery organizations, public works department personnel, all other ESF personnel, and the Emergency Management Assistance Compact (EMAC). These individuals and associations will normally use the present invention to assist in the recovery, assistance, and cleanup after natural disasters such as hurricanes, tornadoes, floods and snow storms. However, the present invention can be used for any situation wherein a number of people require assistance like fires, power blackouts, etc.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. In a Global Positioning System (GPS) effective for coordinating search and rescue efforts said GPS including:
a receiver for receiving signals from a plurality of satellites;
a radio transceiver for transmitting voice communications to and receiving voice communications from other radio transceivers;
a processor coupled to said receiver for calculating a location of said receiver from said satellite signals, said processor including means to receive data;
a storage device coupled to said processor, said storage device storing data representative of waypoints, routes, maps and data supplied by said user;
said means to receive data comprises an input device coupled to said processor for receiving data supplied by a user, said data including waypoints and information related to each said waypoint;
means for transmitting to a base station a plurality of waypoints that have been traversed during a period of time via wireless technology;
whereby coordination of said search and rescue efforts are accomplished.

2. The Global Positioning System of claim 1, wherein said radio transceiver includes a polling device, said polling device includes means for sending a signal to other radio transceivers in the reception area and said other radio transceivers, in response to receiving said signal, broadcasting their waypoint to said radio transceiver sending said signal, whereby the locations of said other radio transceivers can be determined on a map based on said waypoints received.

3. The Global Positioning System of claim 1, wherein said means for transmitting to said base station a plurality of waypoints that have been traversed during a period of time comprises a wireless communication system.

4. The Global Positioning system claim 1, wherein said base station includes means to enter a different map and route into said receiver subsequent to returning to said base station.

5. The Global Positioning system of claim 1, wherein said information related to each said waypoint includes an emergency support function (ESF) designation.

6. A method for coordinating search and recovery efforts in an area comprising:
providing a Global Positioning System (GPS) receiver equipped with a radio transceiver to members of a search team;
modifying the controls and settings of said GPS receiver to enable entry of data and waypoints by operators unfamiliar with the operation of said GPS receiver;
uploading a map into said GPS receiver, said map containing a route;
following said route on said map;
activating a polling feature of said GPS receiver wherein said polling features determine the locations of other GPS receivers without input from the operators of said other GPS receivers;
operating said radio transceiver in a broadcast range which does or does not required a FCC license;
entering data and waypoints at different locations along said route into said GPS receiver and
returning to a base station and wirelessly downloading said data and said waypoints to said base station, whereby coordination of said search and rescue efforts are accomplished.

7. The method of claim 6, wherein a different map and route is entered into said GPS receiver subsequent to returning to said base station.

8. The method of claim 6, wherein emergency support function (ESF) designations are entered into said GPS receiver.

9. In a Global Positioning System (GPS) a method effective for coordinating search and recovery efforts said GPs including:
receiving signals from a plurality of satellites;
transmitting voice communications to and receiving voice communications from radio transceivers;
processor means coupled to a receiver which receives said signals from said plurality of satellites for calculating a location of said receiver from said satellite signals, said processor including input means to receive data from a user;
inputting data representative of waypoints, routes, maps and information supplied by said user to said processor means, said data including said waypoints and information related to each said waypoint via wireless technology;
storing said data representative of said waypoints, routes, maps and information supplied by said user on a storage device coupled to said processor means;
transmitting to a base station a plurality of said waypoints that have been traversed during said period of time and said information related to each said waypoint;
whereby coordination of said search and rescue efforts are accomplished.

10. The method of claim 9, further including activating a polling feature of said GPS receiver wherein said polling feature determines the locations of other GPS receivers without input from the operators of said other GPS receivers.

11. The method of claim 9, wherein a different map and route is entered into said GPS receiver subsequent to returning to said base station.

12. The method of claim 9, wherein emergency support function (ESF) designations are entered into said processor means.

13. A method for coordinating cleanup efforts in an area comprising:
providing a Global Positioning System (GPS) receiver equipped with a radio transceiver to members of a cleanup team;
modifying the controls and settings of said GPS receiver to enable entry of data and waypoints by operators unfamiliar with the operation of said GPS receiver;
uploading a map into said GPS receiver, said map containing a route;
following said route on said map;
activating a polling feature of said GPS receiver wherein said polling features determine the locations of other GPS receivers without input from the operators of said other GPS receivers;
operating said radio transceiver in a broadcast range which does not required a FCC license;
entering data and waypoints at different locations along said route into said GPS receiver, said waypoints indicating locations requiring specific cleanup operations and
returning to a base station and downloading said data and said waypoints to said base station via wireless technology, whereby coordination of said search and recovery efforts are accomplished.

14. The method of claim 13, wherein said members of said cleanup team report to a specific location during said cleanup operation and prior to returning to said base station and down load said waypoints and said data to said base station from said specific location via wireless technology.

15. The method of claim 13, wherein a different map and route is entered into said GPS receiver subsequent to returning to said base station.

16. The method of claim 13, wherein emergency support function (ESF) designations are entered into said GPS receiver.

17. A method for evaluating insurance claims in an area comprising:
providing a Global Positioning System (GPS) receiver equipped with a radio transceiver to members of a cleanup team;
modifying the controls and settings of said GPS receiver to enable entry of data and waypoints by operators unfamiliar with the operation of said GPS receiver;
uploading a map into said GPS receiver, said map containing a route;
following said route on said map;
activating a polling feature of said GPS receiver wherein said polling features determine the locations of other GPS receivers without input from the operators of said other GPS receivers;
operating said radio transceiver in a broadcast range which does or does not required a FCC license;
entering data and waypoints at different locations along said route into said GPS receiver, said waypoints indicating locations requiring specific cleanup operations and
returning to a base station and downloading said data and said waypoints to said base station via wireless technology, whereby coordination of said insurance claim evaluations are accomplished.

18. The method of claim 17, wherein a different map and route is entered into said GPS receiver subsequent to returning to said base station
